(19) United States
(12) Patent Application Publication
(10) Pub. No.: US 2002/0152151 A1
(43) Pub. Date: Oct. 17, 2002

(54) Integrated investment portfolio management system and method

(76) Inventors: William Baughman, Newton, MA (US); Rafael Hernandez, New York, NY (US); Harsh Shethia, London (GB); James A. MacPherson, Cos Cob, CT (US); Joseph Ferguson III, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 09/972,736

(22) Filed: Oct. 5, 2001

Related U.S. Application Data
(60) Provisional application No. 60/238,484, filed on Oct. 6, 2000.

(51) Int. Cl. G06F 17/60

(52) U.S. Cl. 705/36

(57) ABSTRACT

The present invention comprises a system and method that integrates the various steps involved in creating and managing one or more investment portfolios comprised of multiple disparate financial assets, thereby allowing a usr to navigate from need, to insight, to investing and transacting in a logical and straightforward manner. Questionnaires are used to profile each user of the system to determine risk tolerance, time horizon, investment experience, etc. Using the profile and other questions presented to the user, the system generates a recommended asset allocation, which may form the basis of a financial portfolio. The user may construct a portfolio using the financial assets contained in the recommended asset allocation, or select individual assets for inclusion in the portfolio. Upon construction of a portfolio, the system provides tools to monitor and manage the portfolio through the buying and selling of financial assets. Watch lists may also be defined to monitor a collection of financial assets without incurring the risk involved in purchasing the actual financial assets. Furthermore, portfolios may be managed through the use of alerts, which are triggered when defined market conditions are met.

Applicant(s) hereby claims the benefit of provisional patent application serial No. 60/238,484, titled “INTEGRATED INVESTMENT PORTFOLIO MANAGEMENT SYSTEM AND METHOD”, filed Oct. 6, 2000, attorney docket no. 3271/50P, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to integrated investment portfolio systems and methods of operation therefor. More particularly, according to one embodiment, the present invention relates to systems and methods that allows one or more of a user's preferences to serve as the basis for generating and managing one or more portfolios consisting of one of any number of investment instruments or financial assets.

In the current financial service marketplace, a large number of investors are being underserved by their financial providers. This lack of service stems from a variety of factors such as overburdened financial advisors, the fact that many current business models are transaction oriented—leading advisors to focus solely on those customers with the greatest transaction volume, and the fact that financial products have quickly become commodities. Consequently, from the point of view of investors participating in the investment marketplace, the growing array of investment providers, products, and information can be far too complex, impersonal and overwhelming to interpret without detailed advice and guidance.

A variety of systems and methods have been developed to address these issues in an attempt to simplify the investment process. One method that has been developed by financial institutions allows a user to purchase a group of securities in a single transaction. These groups of securities are typically focused on a particular sector or industry, although they may be more broadly based. Systems such as these combine the benefits of mutual find investing (diversification and simplicity) with the advantages of stock ownership (tax management and corporate voting rights), while eliminating may of the disadvantages of both. These systems, however, fail to offer the user advanced features such as basing financial asset recommendations upon the profile of a user (e.g., personalization) or integrating the profiling, asset purchase, and portfolio monitoring processes.

Other tools, such as the one described in U.S. Pat. No. 6,018,722 entitled “SEC Registered Individual Account Investment Advisor Expert System”, provide recommended asset allocations based on risk tolerance, return tradeoffs, time horizon and user experience. Using this system, users are provided with stock recommendations based on up to the minute financial data and economic indicators for securities in the user's portfolio. Recommendations take the form of BUY, BUY/HOLD, HOLD, SELL/HOLD, and SELL. This tool, however, does not provide portfolio tracking tools that allow a user to gauge the relative performance of a portfolio, or individual financial assets contained within a portfolio, over a period of time.

These current systems, therefore, do not provide a “global”, or integrated, solution to the problems faced by investors. There is thus a need for an integrated investment portfolio management system and method that provides an integrated and comprehensive financial solution based on the totality of an investor's financial needs and gives customers greater knowledge, independence and control over both their financial goals and outcomes.

### BRIEF SUMMARY OF THE INVENTION

The present invention comprises a system and method that integrates the various steps involved in creating and managing one or more investment portfolios, which may be comprised of multiple disparate financial assets. More specifically, the system and method of the present invention allows a user to navigate from need, to insight, to investing and transacting in a logical and straightforward manner.

The invention is composed of an integrated computerized investment portfolio management system comprising several integrated software tools. The system comprises an investor profile tool operative to inquire as to a user's preferences to determine at least one of the user's financial needs and goals. An asset allocation tool is used to recommend an asset allocation tailored to at least one of the user's financial needs and goals. A portfolio construction tool is operative to purchase financial assets for inclusion in a portfolio based at least in part on the recommended asset allocation. A fourth tool, a portfolio monitoring tool, monitors at least one of a composition of financial assets within the portfolio and a return generated by the portfolio.

The system and method generates a profile for each user of the system, preferably by using one or more questionnaires. The questionnaires allow the system, through the use of specialized subsystems and subroutines, to determine a user's personal attributes such as risk tolerance, time horizon, and life stage. Based upon the profile generated by the system in response to the answers provided by the user, the system is configured to determine a user's optimal asset allocation.

Assets that comprise the optimal asset allocation may be selected by the user for inclusion in one or more portfolios through the process of profile-based portfolio construction. Through the system, users also have the option of creating self-directed portfolios without using the optimal asset allocation recommendations returned by the system. Alternatively, users may use a combination of recommendations returned from the system in combination with self-directed decisions to generate portfolios. Through links provided to the system from existing trading systems (e.g., an affiliated financial institution), financial assets may be purchased for inclusion in a portfolio or sold for removal from a portfolio. Financial assets may also be transferred between portfolios or into a portfolio or portfolios from an outside account.

In addition to creating portfolios, the system further includes functionality to generate one or more watch lists. Like a portfolio, a watch list is a collection of financial assets selected by the user. Unlike a portfolio, however, there is no requirement that the user purchase the financial assets that comprise the watch list. Instead, the user may assemble the financial assets and monitor the performance of the watch list over a period of time. At any time, the system allows the user to convert a watch list to a portfolio by purchasing all the assets comprising the watch list and saving the resultant purchase data as a portfolio. Links to an affiliated financial institution or institutions allows for the purchase and sale of a variety of financial assets, e.g., stocks, bonds, mutual funds, etc.

Created portfolios and watch lists must be monitored and maintained by the user in order to determine which financial assets must be added or removed over time in order to assure that the portfolio or watch list is performing as desired. The tool provides a user with graphical and textual representations of a selected portfolio or watch list. Preferably, the tool also provides a graphical and textual representation of a benchmark portfolio, which may be the recommended asset allocation generated by the asset allocation tool.

In order to assist a user in automating the monitoring and maintenance of portfolios and watch lists, the system provides an alarm structure to alert users to specific market conditions. Users provide parameters to the system regarding the market conditions that activate the alert. For example, a user may instruct the system to issue an alert when shares of Microsoft Corp. rise above $100.00. Functionality is provided to generate new alerts, modify existing alerts, delete alerts, and deactivate existing alerts while not deleting them from the system.

When market conditions specified by the user are present, the system generates an alert that may be transferred by any variety of means including over the telephone via text-to-speech technology as is well known to those skilled in the art, via electronic mail systems, or the Web. The user receives the alert and may take appropriate action in light of the existing market conditions. The system may also prompt the user to reset the alert and provide new market parameters for reactivating the alert.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting hardware and software components of a system for integrated investment portfolio management, according to one embodiment of the present invention;

FIG. 2 is a conceptual drawing of the interaction between different modules of the system for integrated investment portfolio management, according to one embodiment of the present invention;

FIG. 3 is a screen diagram of an investor profile tool provided by the system for integrated investment portfolio management, according to one embodiment of the present invention;

FIG. 4 is a screen diagram of an asset allocation tool provided by the system for integrated investment portfolio management, according to one embodiment of the present invention;

FIG. 5 is a screen diagram of a portfolio construction tool provided by the system for integrated investment portfolio management, according to one embodiment of the present invention;

FIG. 6 is a screen diagram of a portfolio management and monitoring tool provided by the system for integrated investment portfolio management, according to one embodiment of the present invention;

FIG. 7 is a process model comprising the processes executed by the system for integrated investment portfolio management, according to one embodiment of the present invention; and

FIG. 8 is a process model comprising the continuation of the processes executed by the system for integrated investment portfolio management, according to one embodiment of the present invention.

### DETAILED DESCRIPTION OF THE PREFERRED EMBODIMENTS

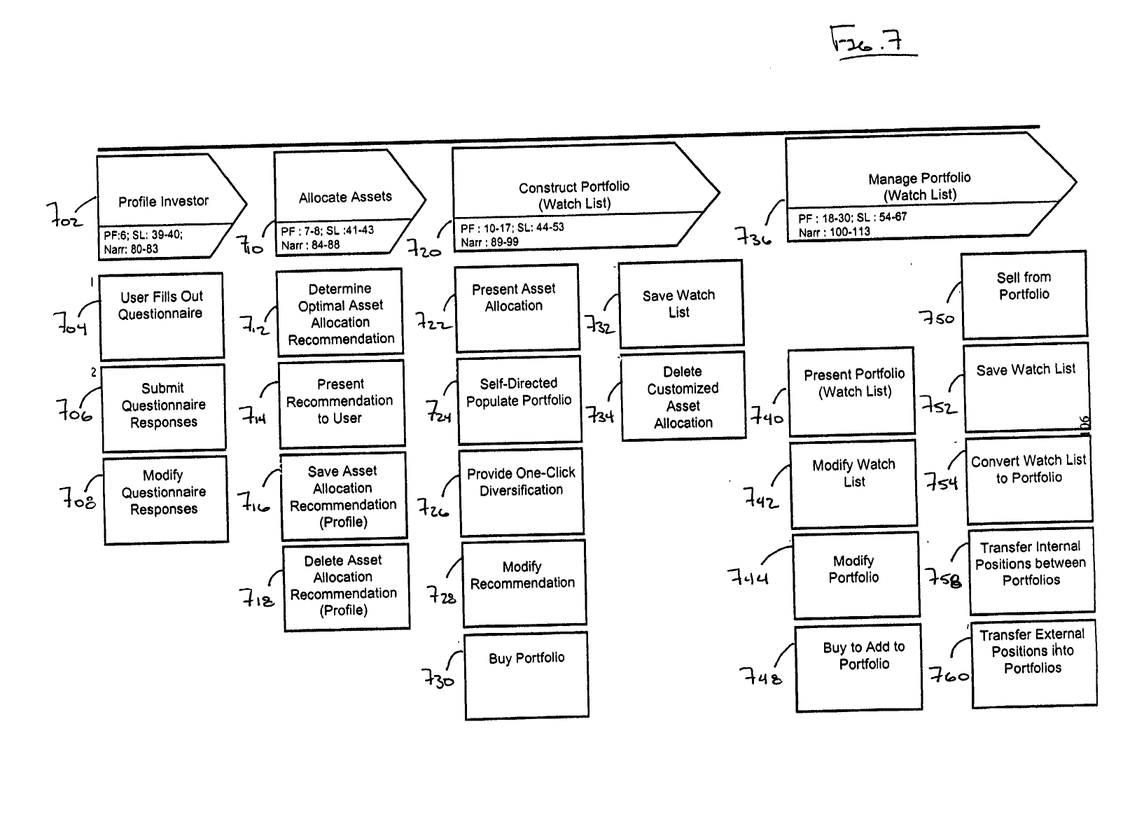

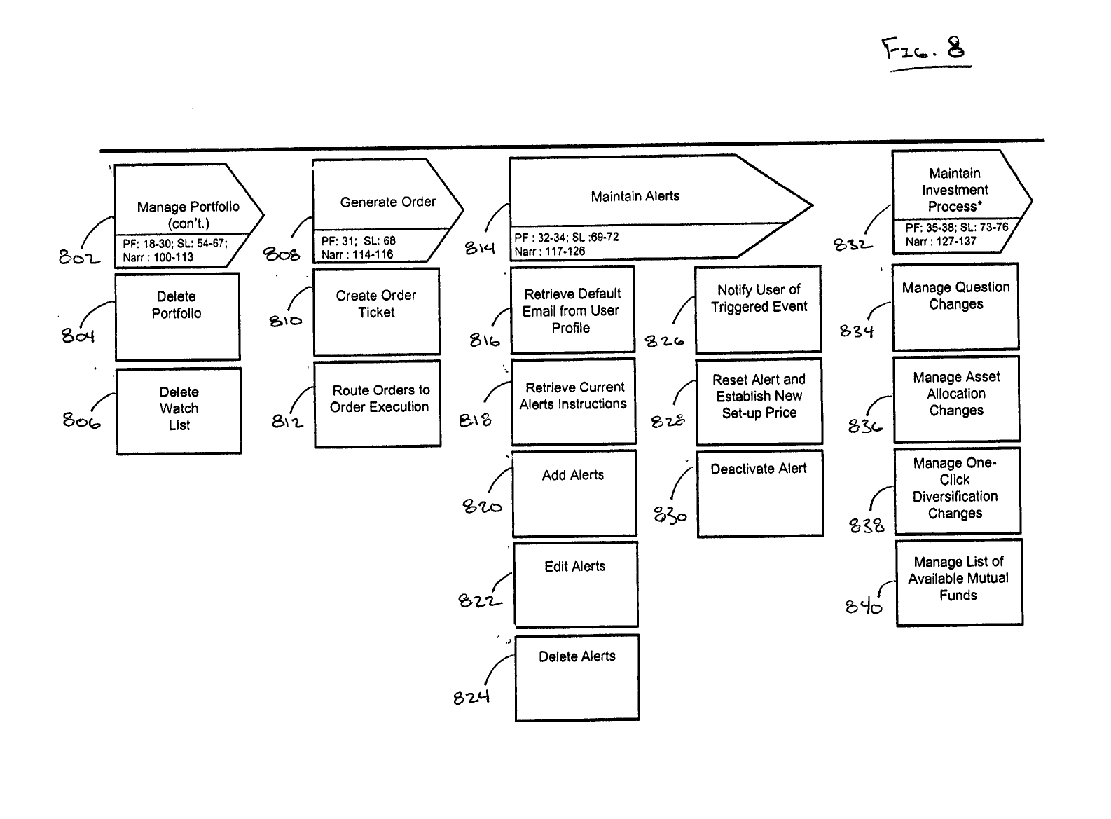

At the end of the Detailed Description of the Preferred Embodiments is an Appendix comprising a series of flow diagrams detailing the processes executed by the process diagrams presented in FIGS. 7 and 8. The appendix is incorporated in an forms a part of the Detailed Description section of the present application.

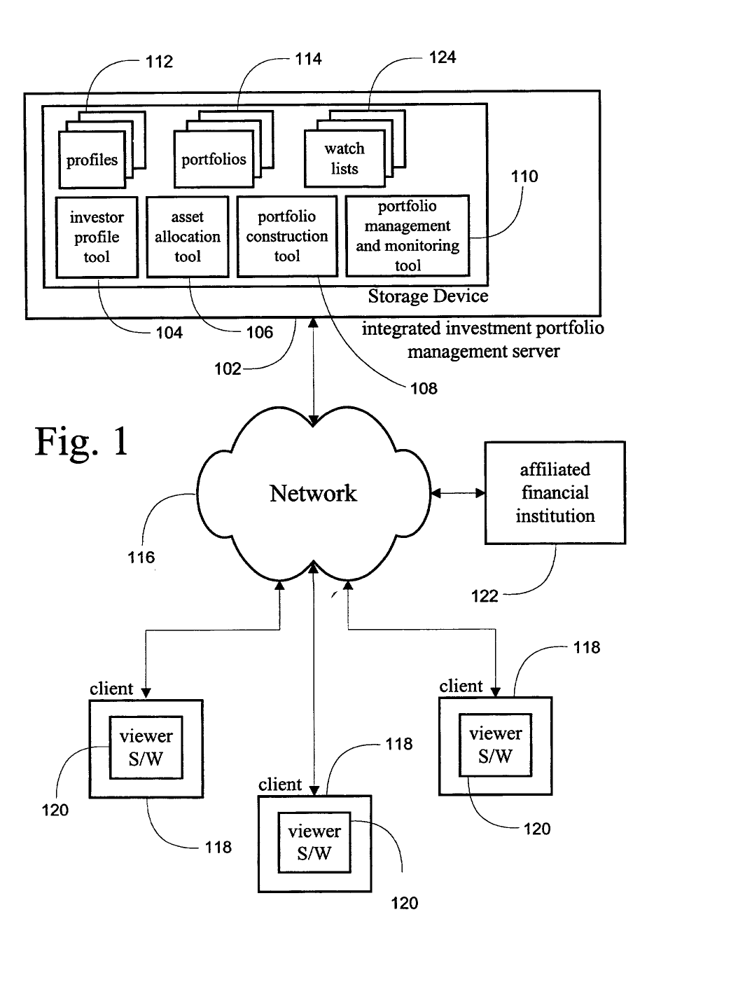

With reference to FIGS. 1 through 8 and the Appendix, embodiments of the system and method for integrated investment portfolio management are presented. Turning to FIG. 1, the hardware and software components of one embodiment of the instant invention are presented, including client devices 118, each containing a software component referred to as viewer software 120. Users access the integrated investment portfolio management server 102 through the use of client devices 118. Client devices 118 may be any general purpose computing devices with the capacity to access a data network 116 including, but not limited to, personal computers, wireless computing devices, personal digital assistants. The data network 116 may be any type of computerized network capable of carrying data, such as the Internet, Intranets, LANs, WANs, etc.

Client device 118 contains and executes viewer software 120 in order to connect to the integrated investment portfolio management server 102, which provides content and processes used in developing and maintaining an investment portfolio. The viewer software 120 may execute routines on the client 118 when a connection is established with the server 102. Alternatively, according to other embodiments, the viewer software 120 simply receives GUI or screen data for display on the client 118, with all program logic residing on the server 102. An exemplary and versatile viewer software application 120 is a web browser, which is capable of presenting graphical and textual information to a user in addition to receiving and transmitting user input. The viewer software 120 is the conduit through which the user interacts with the financial service modules 104, 106, 108, and 110, resident on the server 102.

When a client 118 makes a connection with the integrated investment portfolio management server 102, a check is performed to determine if the user has already established a profile 112. Where the user has either not created a profile, or desires a new profile to be generated, control is passed to the investor profile tool 104. The investor profile tool poses a series of questionnaires to a user in order to compile a profile 112. The questionnaire consists of a series of simple questions related to a user's investment time horizon, life stage, financial goals, risk tolerances, etc. The user profile, as well as other data files described herein (e.g., portfolios, watch lists, etc.), may be stored on one or more of any number of data storage devices and systems including, relational databases, object-oriented databases, hybrid relational-object databases, flat-file databases, etc.

The answers are complied into a profile 112, which is used to develop one or more suggested asset allocations tailored to the user's profile. Preferably, the asset allocations are presented graphically, such as in a pie chart, to simplify the process of presenting the various financial assets comprising the suggested asset allocation. Additionally, other (e.g., textual) information is presented with the graphical representation of the asset allocation, such as returns over various time horizons, percent returns compared to indexes, volatility, and highs and lows for each asset in the asset allocation over a selected time horizon. The suggested asset allocation is for informational purposes only, and may be used as input to the advanced asset allocation tool 106 or for building an actual portfolio by using the portfolio construction tool 108.

The system also comprises an advanced asset allocation tool 106 that provides more detailed breakdowns of each asset class that that provided by the investor profile tool 104. Direct links are provided between the investor profile tool 104 and the advanced asset allocation tool 106. The advanced asset tool 106 may optionally prompt the user to answer a series of detailed questions about their investment goals and risk tolerances including risk tolerances within each asset class, goal specific capital needs, education, wealth management goals, etc. The answers from the advanced asset allocation tool questionnaire are used to determine one or more suggested advanced asset allocations, preferably presented in both graphical and textual forms.

The advanced assets allocation suggests major asset classes and more detailed breakdowns of each asset class, e.g., international, domestic, large cap, small cap, short-term, long-term, etc. Each advanced asset allocation also includes a text description of the investment strategy and historic returns for the asset over a variety of time periods, volatility, and highs and lows over user defined time periods. As with the asset allocations provided by the investor profile tool 104, the suggested asset allocations are for informational purposes only and may be used as a basis for building an actual portfolio 114 through the use of the portfolio construction tool 108.

Both the investor profile tool 104 and the advanced asset allocation tool 106 use a rules based system to determine the recommended asset allocation. The recommendation considers suitability, compliance, and business risk parameters when presenting an asset allocation to a user. The recommended asset allocation determines the appropriate mix of fixed income and equity instruments based on the user's response to profile questions. A weighting system is coupled with responses to questions and focuses on risk, time, and investment experience. Incorporating user responses and weights given to each question in the questionnaire, the tools return a set of asset allocation percentages corresponding to the level of investment by which the user should commit. For example, 25 percent fixed income and 75 percent equities. Tables 1 and 2 present an exemplary weighting and scoring system, respectively.

TABLE 1

| Questionnaire | | | |
|---|---|---|---|
| weighting | Risk | Experience | Time |
| Question 1 = 15 | 15 | | |
| Question 2 = 10 | | 10 | |
| Question 3 = 12.5 | 7.5 | 5 | |
| Question 4 = 17.5 | | | 17.5 |
| Question 5 = 17.5 | | | 17.5 |
| Question 6 = 12.5 | 7.5 | 5 | |
| Question 7 = 15 | 15 | | |
| Total Weighting = | 45 | 20 | 35 |
| 100 | | | |

TABLE 2

| | |
|---|---|
| 81-100 | Aggressive |
| 61-80 | Moderately aggressive |
| 41-60 | Moderate |
| 21-40 | Conservative |
| 0-20 | Defensive |

The user, through the use of a client device 120 executing viewer software 118, interacts with the investor profile tool 104 and advanced asset allocation tool 106 to create profiles and generate suggested asset allocations. Based on suggested assets allocations returned by the tools, 104 and 106, the user may create one or more actual portfolios 114 through the use of the portfolio construction tool 108. The portfolio construction tool 108 provides a user with tools to create an actual portfolio 114. The tool may be used to create a new portfolio, a portfolio that contains outside holdings, or a watch list (explained herein).

The portfolio construction tool 106 presents a graphical representation of the portfolio 114 as the user builds it, e.g., a pie chart delimited by asset type. The user selects an asset class section (e.g., fixed income, equity, cash, etc.) of the portfolio 114, which generates a drop down menu or other graphical selection tool providing investment choices. For example, stocks and mutual funds are presented in alphabetical order. Financial assets may also be presented by sector, such as technology, durables, utilities, etc. Individual entries may be further marked with icons to identify buy, sell, or hold recommendations. Sub-menus are also presented for navigating through financial assets by price, P/E ratio, earnings per share (EPS), market capitalization, risk factors, relative strength, etc. Finally, the portfolio construction tool 108 is operative to retrieve detailed research on any financial asset selected by retrieving it from an affiliated financial institution 122.

Using the tool 108, users can purchase the financial assets selected through the interface provided. The system generates electronic trade tickets that are placed in an electronic “order basket” (not pictured) that is a temporary data structure to hold unexecuted tickets before execution. An instruction to execute an order ticket transfers the ticket to the affiliated financial institution 122 for processing. Upon execution of the order by the affiliated financial institution 122, order confirmation data is routed back to the system 102 across the network 116. The portfolio construction tool 108 receives the order execution confirmation, which causes the graphical and textual representations of the portfolio to be modified, as well as the data in the user's portfolio data structure 114.

The portfolio creation tool 108 also provides for “one click” portfolio diversification, allowing a portfolio to be populated with recommended financial assets in a single action. The tool 108 considers suitability, compliance and business risk management parameters when generating the one click diversification. Detailed listings of the finds included in the diversification appear on the client device 118. Each risk category identified by the system 102 is associated with a set of financial assets that are included in the pre-population.

The one click diversification process enables a user to submit multiple orders simultaneously, thereby allowing for quick and effortless submission of orders across different asset class types. If a user chooses the one click option presented by the tool 108, he or she is prompted to enter a dollar amount that is proportionally distributed among the recommended assets. As is explained in greater detail herein, the transaction handling processes are activated. According to some embodiments, these sets of assets are reviewed and updated periodically, either by the system 102 or an administrator to ensure the assets included in the diversification are consistent with the risk level that they are associated with.

The final tool used to integrate a user's financial needs and goals is the portfolio management and monitoring tool 110. This tool 110 allows a user to manage their portfolio and preferably compare it to the suggested asset allocation provided by the system 102, specifically, by the investor profile tool 104 and advance asset allocation tool 106. Users may monitor the value of their overall portfolio, as well as the value of individual assets within each portfolio they have created. According to some embodiments of the invention, the suggested portfolio generated by the investor profile and asset allocation tools is presented in conjunction with the user's actual portfolio to serve as a “benchmark” to gauge portfolio performance against suggestions provided by the system.

Financial assets are bought or sold by supplying a ticker symbol or other accepted financial identifier to the tool 110, as well as a purchase or sale amount. The tool 110 validates these values before the transaction is routed to an affiliated financial institution 122. Upon confirmation of the execution of the order, the tool 110 updates the user's portfolio 114, which is graphically presented on the client device 118 through the viewer software 120. Similarly, where the user desires to sell assets from a portfolio 114, an asset for sale is identified along with a sell value, which is executed. The portfolio data 114 is updated upon receipt of the sell execution.

In addition to using the portfolio construction 108 and portfolio management tools 110 to create and manage portfolios of financial assets, the system 102 provides the ability for users to generate and maintain watch lists 124. Like a portfolio 114, a watch list is a data item of file containing a grouping or collection of financial assets. Unlike a portfolio 114, however, a user does not actually own any of the financial assets grouped as a watch list 124. The watch list 124 provides a mechanism through which the user may view the performance of a group of assets without assuming the risk involved with ownership of the assets.

The portfolio management tool 110 also allows a user to add and remove financial assets to a watch list 124 using GUI controls presented by the viewer software 118 executing on the client device 118. A user simply supplies a ticker symbol or other financial asset identifier to the system along with a currency value or number of shares, which the tool will save in the user's watch list 124. Likewise, users may remove all or part of an asset or assets from a watch list by supplying an identifier and amount value.

The portfolio management tool 110 further provides functionality that allows a user to purchase the assets containing in a watch list 124, thereby converting it into a portfolio 114. An order ticket is generated for all assets contained in the watch list 124, which is routed via the network 116 to an affiliated financial institution 122. The assets are purchased and the user's account with the financial institution 122 is debited. The order confirmation is returned to the system 102, which converts the user's watch list 124 into a portfolio 114. Alternatively, the assets purchased from a watch list 124 may be combined with assets in an already existing portfolio 114.

Another feature of the portfolio management tool 110 is the ability to set and trigger alerts. Alerts are set by a user for an entire portfolio or specific assets within a portfolio 114 or portfolios. When the value of an asset within a portfolio, or the value of a particular portfolio, falls below or rises above a level set by the user, an alert is generated by the system 102 and delivered via the network 116 to the user's client device 118. In this manner, a user may be kept abreast of the changes in value to particular financial assets or the value of an entire portfolio. When an alert is received, the user may access the portfolio management tool 110 and take appropriate action, e.g., buying or selling a financial asset or accessing the asset allocation tool 106 for new portfolio recommendations in light of the information contained in the alert. Alternatively, an alert may be issued by the system 102 to one or more users to alert the user to particular market conditions or the availability of a new financial asset in the marketplace.

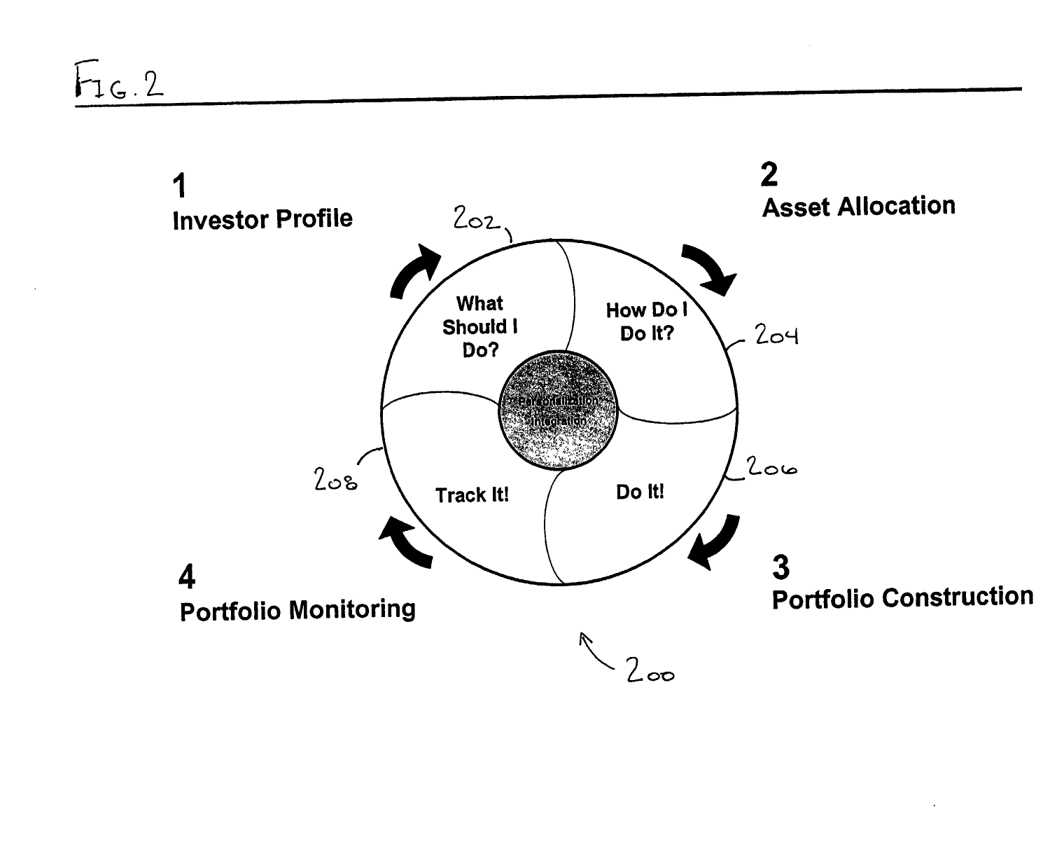

A conceptual drawing of the integration of the various tools presented in FIG. 1 that comprise the overall system is presented in FIG. 2. As the overall diagram makes clear, the tools that comprise the system 202, 204, 206, and 208, integrate seamlessly to provide a total solution for financial portfolio creation and management. The first step in the process for a new user, or a user who wants to “reprofile” his or her financial needs and goals, is to access the investor profile tool 202. Using the investor profile tool 202, the system 200 is capable of obtaining profile information regarding the user's risk tolerance, time horizon, financial goals, etc. This data forms the basis for the system 200 to provide recommendations regarding financial assets that are congruent with the user's financial needs and goals.

Information collected by the investor profile toll 202 is analyzed and stored as a profile that forms the basic input parameters for the asset allocation tool 204. In addition to using data compiled by the investor profile tool 202, the asset allocation tool 204 may collect more detailed data regarding the user's risk tolerance in one or more asset classes, goal specific capital needs, wealth management goals, etc. Based on this extended information, the tool 204 suggests major asset classes and a comprehensive breakdown of each asset class. The user is free to take the system recommendations in whole, in part, or not at all. In this manner, the user moves from determining what they need to do financially (the investor profile tool 202 ) to how they should do what is financially required for fiscal success (the asset allocation tool 204 ).

The foundation of financial asset suggestions generated by the asset allocation tool, based upon the information collected by the investor profile tool 202 and the asset allocation tool 204, is used to create one or more financial portfolios by the portfolio construction tool 206. Using links to an affiliated financial institution, e.g., Deutsche Bank, currency is identified for purchasing financial assets. Users interact with the tool 206 to select desired financial assets such as stocks, mutual funds, bonds, etc. At this point, financial assets sleeted may be of the user's personal liking, selected from the suggested financial assets that are in line with the user's needs and goals as identified by the investor profile tool 202 and asset allocation tool 204, or a combination of the two. The selected assets are purchased from the affiliate financial institution, as is well known to those skilled in the art, and recorded in the user's portfolio. In this manner, the user moves from determining how they should do what is financially required for fiscal success (the asset allocation tool 204 ) to actually purchasing the assets that enable fiscal security (the portfolio construction tool 206 ).

After the user has purchased a portfolio of assets, it becomes necessary to monitor the health of the portfolio, which is accomplished through the portfolio monitoring tool 208. Using the tool 208, the user is presented with a graphical and textual representation of the contents of the portfolio. The visual representation allows users to easily determine the return being generated by their portfolio, as well as the return being generated by individual assets within the portfolio and the distribution between asset types. Furthermore, these graphical and textual representations may be compared against investment goals derived by the system during the questionnaire process presented by the investor profile tool 202 and asset allocation tool 204.

When users feel that particular assets are not performing as expected, or that new or additional financial assets are desired for purchase, the portfolio construction tool 206 may be used to buy or sell financial assets to bring their portfolio in line with their financial goals. The resultant modified portfolio is then monitored using the portfolio monitoring tool 208 to ensure that the changes are not having a deleterious effect on the portfolio as a whole. In this manner, users may monitor the performance of their financial assets in relation to their investment goals, creating a completely integrated and personalized portfolio management system.

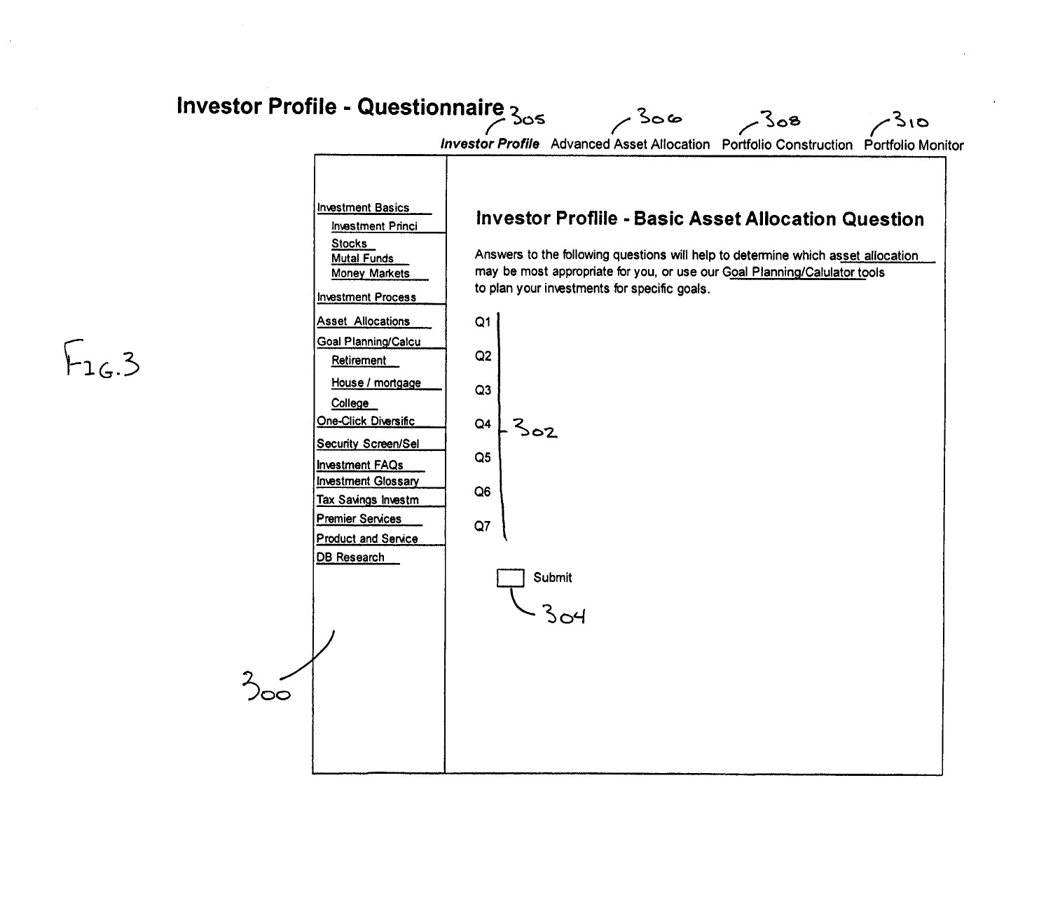

According to some embodiments, the integrated investment portfolio management system is presented as one or more graphical screens presented by the system to the client device via the device's viewer software. A screen drawing presenting the investor profile too according to one embodiment is presented in FIG. 3. The investor profile tool comprises a link bar 300 within its display space. This space contains links to other financial resources that may or may not be hosted by the institution hosting the integrated management system. For example, the links may be hypertext links directing the user to locations scattered across the Internet or other computer networks.

The investor profile tool also presents a series of question within its display space 302. While no actual questions are presented in the diagram, exemplary questions include questions regarding risk tolerance (e.g., “what are you most concerned about when you invest?”) and time horizon (e.g., “what is your age?”). The user completes the questionnaire and the “submit” button 304 is selected, which causes the system to evaluate the user's responses and store the responses and analysis as a profile. Also provided are direct links to the other tools that comprise the system including advanced asset allocation 306, portfolio construction 308, and portfolio monitoring 310.

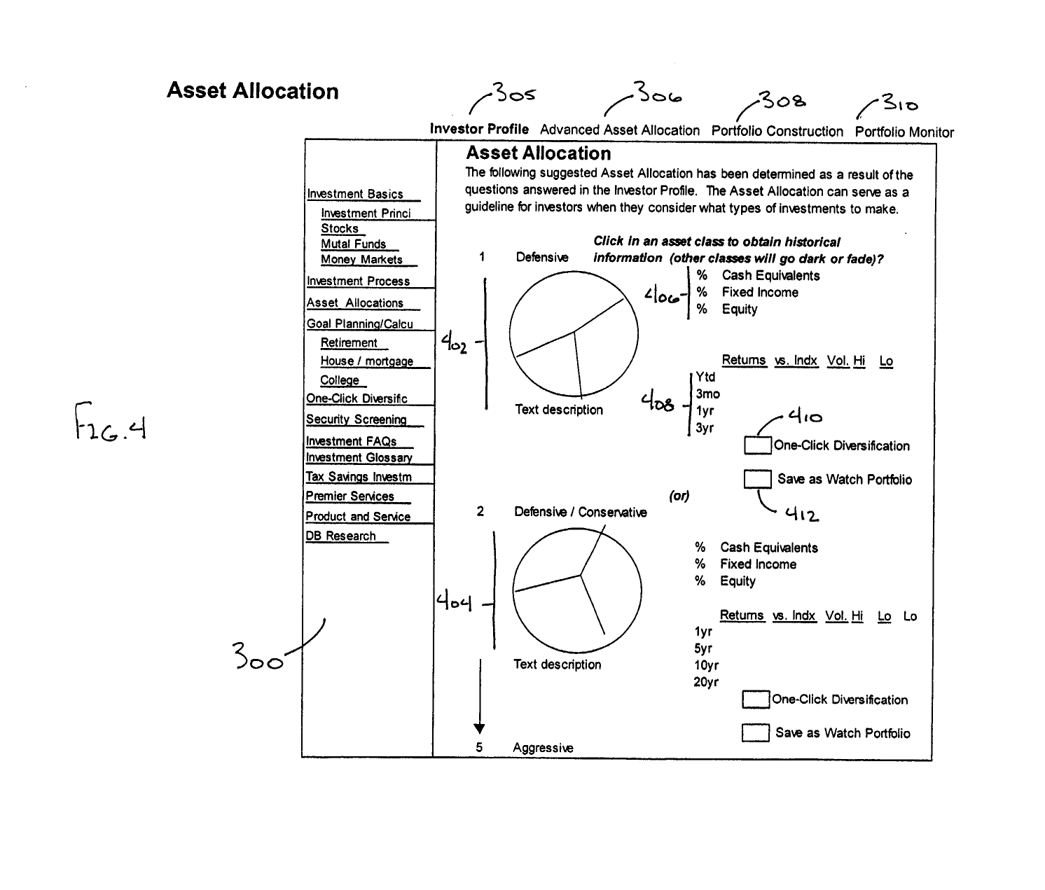

The advanced asset allocation tool has a separate screen drawing presented in FIG. 4. As with the investor profile tool, the advanced asset allocation tool comprises a link bar 300 within its display space. This space contains links to other financial resources that may or may not be hosted by the institution hosting the integrated management system. The asset allocation tool receives the analyzed responses derived from the responses provided to the investor profile tool and generates one or more recommended asset allocations based on one or more risk tolerances. In the example provided, asset allocations related to defensive 402 and defensive/conservative 414 risk tolerances are presented.

Accompanying each of these asset allocations is extended textual data providing the breakdown of the financial assets that comprise the asset allocation 406. Also presented are the returns for each asset allocation 408, which is derived by the system either by analyzing the financial assets that comprise the asset allocation or through transfer of financial data from an affiliated financial institution. Also provided are controls to save the asset allocation as a watch list 412, which simply saves the allocation to a storage device accessible by the system, and to select a one-click diversification 410, whereby all the assets that comprise a recommended asset allocation are purchased in a single action.

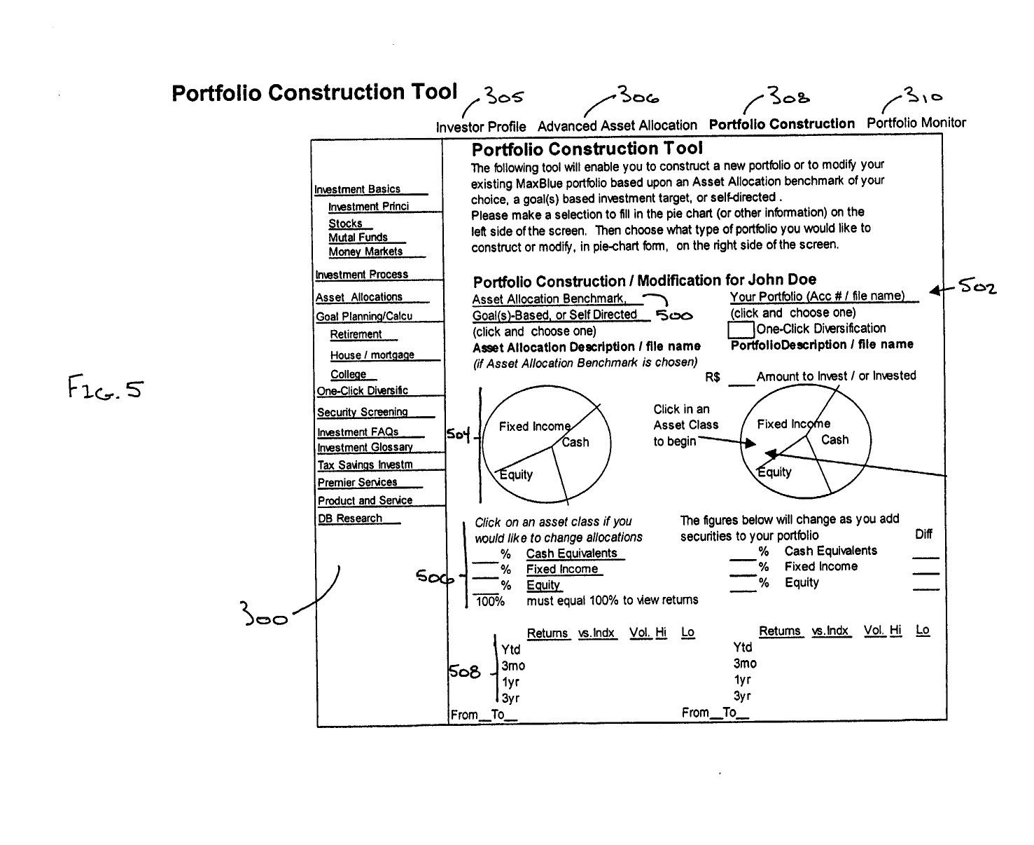

Another tool comprising the system, the portfolio construction tool, is presented in FIG. 5. Within the tool's display space is displayed both a graphical and textual representation of a currently selected portfolio 502. Also displayed is a benchmark portfolio 500 to compare the currently created portfolio against. For both the created portfolio 502 and a benchmark portfolio 500, a graphical representation of the asset allocation comprising each portfolio is presented 504.

In order to construct the portfolio by adding or removing financial assets, the user may select an asset type from the graphical presentation and instruct the system to change the assets allocated to the asset type by providing an asset identifier and purchase or sell amount. Correspondingly, a textual representation of the asset allocation 506 is provided listing the percentages allocated to each asset type. Selecting an asset type from the textual representation 506 and instructing the system to change the assets allocated to the asset type by providing an asset identifier and purchase or sell amount constructs the portfolio. Finally, the returns 508 for the currently constructed profile and benchmark are provided to the user to gain insight into the historical return for the financial assets and allocation for the constructed portfolio. The historical return data is derived by the system either by analyzing the financial assets that comprise the constructed portfolio or through transfer of financial data from an affiliated financial institution.

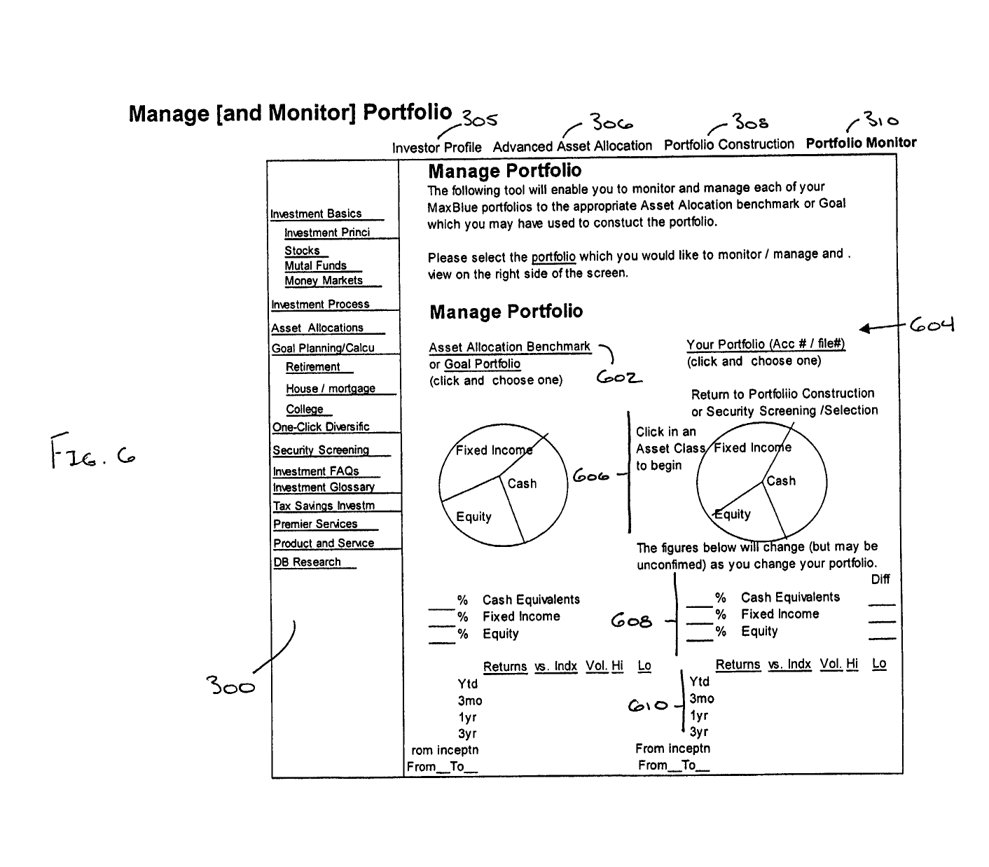

A screen drawing presenting the final tool comprising the system, the portfolio management tool, is presented in FIG. 6. As with the portfolio construction tool presented in FIG. 5, he portfolio management tool preferably comprises data regarding a benchmark portfolio 602 presented alongside an actual portfolio or watch list 604 created by the user. Using the portfolio management tool, users may select an asset allocation graphically presented by the tool 606 for monitoring.

Selecting an asset allocation instructs the tool, as will be explained in greater detail herein, to execute one or more routines that allow assets comprising the selected asset allocation to be bought or sold, thereby changing the composition of the asset allocation. Alternatively, a textual description 608 of the percentage of the portfolio, watch list, or benchmark is provided. Selecting an asset allocation from the textual description instructs the tool to execute one or more routines that allow assets comprising the selected asset allocation to be bought or sold, thereby changing the composition of the asset allocation. Regardless of whether asset allocation is modified via the graphical or textual representation, both representations are updated with regard to the new composition of the portfolio, watch list, or benchmark. Also provided is a historical return of the assets comprising the portfolio or benchmark 610, which may be generated by the system through analysis of the individual financial assets that comprise the portfolio or through data received from an affiliated financial institution.

A process model representing the processes executed by the tools presented in FIGS. 1 through 6 is presented in FIGS. 7 and 8. The process models represent high level processes executed by the above described software modules. A detailed breakdown of the steps executed by each of the processes is provided in the Appendix.

Turning to FIG. 7, the integrated investment process begins by the system profiling the investor 702. The process of profiling an investor comprises the user executing a personal and financial questionnaire 704 that collects information regarding the user, the user's time horizon, risk tolerance, etc. The detailed process of presenting the questionnaire to the user is presented in the Appendix at 2.1.1. The completed questionnaire is submitted to the system 706 where it is stored as a profile on a storage device accessible by the system (see generally Appendix 2.1.2). The user also has an opportunity to modify the responses he or she provided to the system via the questionnaire 708 (see generally Appendix 2.1.2), which is then saved in place of the existing profile. The process of modifying the questionnaire 708 can be enacted at any time that is desired by the user.

The completed questionnaire is stored by the system as a profile 702 and used to generate a suggested asset allocation 710 (see generally Appendix 2.1.2.1). Using the questions that are provided by the profiling process as input parameters, the asset allocation tool presents an additional set of detailed questions for completion. The asset allocation tool generates a recommended optimal asset allocation based on the user's responses to the questions provided 712. The recommended optimal asset allocation is presented to the user via viewer software executing on the client device 714. The user also has an opportunity to save the recommended optimal asset allocation as part of his or her profile 716. Since the asset allocation is stored as part of a user's profile, the user has an opportunity, at any time, to remove the recommended asset allocation from his or her profile 718 or generate a new asset allocation (see generally Appendix 2.1.2.4).

The process continues with the user constructing one or more portfolios or watch lists 720 (see generally Appendix 2.1.3). As described above, the watch list is a portfolio of assets that have not actually been purchased, but serves as a mechanism that allows the user to track a hypothetical portfolio and purchase the assets if desired. An asset allocation is presented to the user 722, preferably the recommended asset allocation optimally suited to the investor's profile as defined by his or her responses to the questionnaires, 702 and 710. The user may opt to discard the recommended asset allocation and instead create a self-directed portfolio 724 whereby the user independently selects financial assets for inclusion in a portfolio (see generally Appendix 2.1.3.2). Alternatively, the user can opt for one click diversification 726 whereby the system generates a diversified portfolio of financial assets tailored to the user's time horizon, risk tolerance, etc., and purchases all the assets in the recommendation in one action (see generally Appendix 2.1.3.3). The user is also provided with an opportunity to modify any portfolio recommendations returned by the system 728 (see generally Appendix 2.1.3.4). When the user is satisfied with the financial assets selected for inclusion within the portfolio, the financial assets are purchased 730 (see generally Appendix 2.1.3.5) through links to trading systems hosted by affiliated financial institutions as is well known to those skilled in the art. Watch lists, generated in a similar manner to the generation of portfolios, may also be save by the system (see generally Appendix 2.1.3.6).

A portfolio or watch list is generated and saved by the system, which is then monitored and managed by the user 736 (see generally Appendix 2.1.4). The user selects a previously saved portfolio or watch list for presentation by the system 740 via the viewer software on the client device 740. Processes are provided to allow the user to modify the financial assets that comprise a watch list 742 (see generally Appendix 2.1.4.3), e.g., add and remove equities, and issue instructions to the system to save the resultant watch list 752. Likewise, the user is capable of instructing the system to modify a saved portfolio 744 (see generally Appendix 2.1.4.4) through interaction with the affiliated financial institution.

The process of modifying a portfolio invokes a sub-process depending on the modification desired by the user (see generally Appendix 2.1.4.5 and 2.1.5). Where the user wishes to purchase additional financial assets to add to a portfolio 748, a buy ticket is generated as explained herein with the financial parameters provided by the user, which is transmitted to the affiliated financial institution for settlement. If the user wishes to sell financial assets from a portfolio 750, a sell ticket is generated as explained herein with the financial parameters provided by the user, which is transmitted to the affiliated financial institution for execution and settlement.

Functions also allow a user to convert a watch list to a portfolio 754, by generating buy tickets for each of the financial assets that comprise the selected watch list and recording the resultant transaction as a portfolio associated with the user, as well as transfer financial assets (see generally Appendix 2.1.4.8). Users who have created multiple portfolios may simply select financial assets from a first portfolio and transfer them into a second portfolio 758 (see generally Appendix 2.1.4.9), or transfer financial assets managed by other systems into a user's portfolio 760. Continuing on FIG. 8, whole portfolios 804 and watch lists 806 may be deleted from the system . When deleting a watch list 806, the system simply erases the stored watch list from memory as no financial assets have actually been purchased (see generally Appendix 2.1.4.12). Deleting a portfolio 804, however requires the system to generate one or more sell tickets for transmission to the associated financial institution instructing that the financial assets contained in the portfolio be sold (see generally Appendix 2.1.4.11).

As discussed above, tickets are generated by the system when the user wishes to buy or sell financial assets, 748, 750, and 804 (see generally Appendix 2.1.5). Each of these sub-processes invokes an order generator process 808. The process receives the transaction parameters, for example, a number of shares of stock or mutual funds to sell accompanied by an identifier for the stock or mutual find. These data are used to generate an order ticket for transaction 810; the order ticket conforming to the particular format adhered to by the affiliated financial institution executing the transaction. The order is routed across a computer network to an affiliated financial institution for execution and settlement 812. According to some embodiments of the invention, the process of routing orders for execution 812 comprises the software tools required to execute the transaction internal to the system, for example, in situations where the system is operated within a financial institution.

As discussed above, the portfolio management tool comprises functionality that allows users to set and maintain alerts vis-a-vis both portfolios and the individual assets contained therein 814 (see generally Appendix 2.1.6). When the user first activates the alert processes, a default email address is provided in order to maintain an address to which alert notices may be mailed 816. When the alert processes start, a routine is invoked to retrieve any previously saved alerts and the status of those alerts 818, e.g., active or inactive. The portfolio management tool provides processes to instruct the system to add 820 and delete 824 alerts, as well as edit the parameters that instruct the system to execute an alert 822, e.g., the user instructs the system to issue an alert when the price of one share of Intel Corp. falls below $ 70.00. Furthermore, alerts may be deactivated without deleting the alert 830, allowing later reactivation (see generally Appendix 2.1.6.3 through 2.1.6.5).

Users provide parameters to the system instructing it when to issue an alert, 820 and 822 (see generally Appendix 2.1.6.6). When the parameters provided by the user occur in the marketplace, the portfolio management tool executes a notify user process 826 that generates and email informing the user that the market conditions they wished to be notified of are occurring. According to some embodiments of the invention, extended marketplace data may be transmitted to the user to allow him or her to respond to the alert in an informed manner. The portfolio management tool also prompts the user to reset an alert 828, which involves providing new market or financial asset parameters under which the alert is executed.

As like most other computer-based tools, maintenance processes are provided through which the system may be modified 832. A system administrator or other party managing the system may modify existing questionnaires (see generally Appendix 2.1.7.1), including the weighting assigned to individual questions, or provide entirely new questionnaires and weighting systems 834. Likewise, the asset allocations assigned to different risk tolerances 836 (see generally Appendix 2.1.7.2) and one click diversification 838 may be changed as different financial assets change their performance over time (see generally Appendix 2.1.7.3). Finally, the administrator may add or remove financial assets available for purchase through the system 840 (see generally Appendix 2.1.7.4). As explained above, flowcharts further detailing the steps executed by each process are provided in the Appendix.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An integrated computerized investment portfolio management system comprising:
an investor profile tool operative to inquire as to a user's preferences to determine at least one of the user's financial needs and goals;
an asset allocation tool to recommend an asset allocation tailored to at least one of the user's financial needs and goals;
a portfolio construction tool operative to purchase financial assets for inclusion in a portfolio based at least in part on the recommended asset allocation; and
a portfolio monitoring tool to monitor at least one of a composition of financial assets within the portfolio and a return generated by the portfolio.

2. The system of claim 1 wherein the investor profile tool presents a questionnaire to conduct the inquiry.

3. The system of claim 2 wherein the investor profile tool analyzes responses to the questionnaire to determine at least one of risk tolerance, time horizon, and user experience.

4. The system of claim 1 wherein the asset allocation tool uses responses to the questionnaire to calculate the recommended asset allocation of financial assets.

5. The system of claim 4 wherein the user generates a portfolio comprising the recommended financial asset allocation utilizing the portfolio construction tool.

6. The system of claim 1 wherein the portfolio construction tool is operative to generate the portfolio comprising diversified financial assets.

7. The system of claim 1 wherein the user creates and maintains one or more alerts that are triggered when specified market conditions are present in a financial marketplace.

8. The system of claim 1 wherein the user generates the portfolio comprising asset not recommended by the asset allocation tool.

9. The system of claim 1 comprising one or more watch lists consisting of financial assets to be monitored without purchasing the financial assets.

10. The system of claim 1 wherein the user's responses to the questionnaire are stored in a profile.

11. The system of claim 1 wherein the portfolio monitoring tool is operative to monitor the return generated by specific financial assets comprising the portfolio.
